(19) United States
(12) Patent Application Publication
(10) Pub. No.: US 2007/0085754 A1
(43) Pub. Date: Apr. 19, 2007

(54) RF front-end architecture for a separate non-50 ohm antenna system

(75) Inventors: Juha Ella, Halikko (FI); Jani Ollikainen, Helsinki (FI); Tero Ranta, Turku (FI); Anping Zhao, Espoo (FI); Jussi Rahola, Espoo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/253,011

(22) Filed: Oct. 18, 2005

(51) Int. Cl. H01Q 1/50

(52) U.S. Cl. 343/862

(57) ABSTRACT

A transceiver system having an RF front-end operatively connected to two separate non-50 ohm antennas for separately providing transmission/reception paths for 1 GHz band and for 2 GHz band. A switching module is operatively connected to each antenna for mode and frequency-range selection within each band. Each switching module has a plurality of switching elements connected to a plurality of signal paths. Matching is separately and independently provided for each signal path. The matching can be achieved by using distributed elements or lumped elements arranged in shunt or series in order to widen the bandwidth. An electrostatic discharge protection circuit is provided between the antenna feed point and the switching module. The protective circuit can also be used as a discrete matching network that can be optimized depending on the phone mechanics and dimensions.

### FIELD OF THE INVENTION

The present invention relates generally to the RF front-end part of a radio and, more particularly, to an RF front-end in a multiband, multimode communication engine in a mobile phone.

### BACKGROUND OF THE INVENTION

It is known in the art that the conventional antenna that provides a 50 ohm interface to the front end is sensitive to disturbances in the near field (head, fingers etc). This sensitivity can be dramatically decreased if the antenna is simplified and some of the matching components are moved to the front-end. Typically antenna matching is achieved by internal parasitic loads or the like, and the matching components can be either discrete or integrated passive components. A major problem to be solved is how to improve the total efficiency of the antenna and the associated front-end in a mobile phone considering the variations in the user's head and hand position. Another major problem to be solved is how to minimize the degradation in antenna performance when the antenna size is reduced.

A general problem associated with mobile phone antennas is the difficulty in designing a signal antenna for both 1 GHz band and 2 GHz band. Changes in the antenna element or other phone mechanics may change one or both of the bands.

It is known in the art to provide matching for non-50 ohm antennas. A typical non-50 ohm antenna is illustrated in FIG. 1. An equivalent circuit of a fixed matching network for a non-50 ohm antenna is shown in FIG. 2. As shown in FIG. 2, some matching elements are for impedance level transformation and some are for widening the bandwidth of the antenna. Simple matching circuits for non-50 ohm antennas are shown in FIGS. 3a and 3b. The circuit comprises a series element and a shunt element. The series element can be a capacitor or an inductor. The shunt element can also be a capacitor or an inductor

It is also known to split the bands by a switching element at the antenna feed point and to put the matching after the switch element in order to optimize the performance for each band separately. For example, Ella et al. (U.S. Patent Publication No. 2005/0085260 A1) discloses a receive front-end wherein the front-end is split into 1 GHz band and 2 GHz at the feed point of the antenna. However, matching for each band in such splitting may not be optimum when there is a large number of GSM/W-CDMA modes to be used in a mobile phone.

### SUMMARY OF THE INVENTION

The present invention uses two separate antennas for separately providing transmission/reception paths for 1 GHz band and for 2 GHz band. The antennas are non-50 ohm antennas and possibly non-resonating. A switching module is operatively connected to each antenna for mode and frequency-range selection within each band. Each switching module has a plurality of switching elements connected to a plurality of signal paths. Matching is separately and independently provided for each signal path. The matching can be achieved by using distributed elements or lumped elements arranged in shunt or series in order to widen the bandwidth. An electrostatic discharge protection circuit is provided between the antenna feed point and the switching module. This protective circuit comprises a shunt coil to ground and a microstrip between the antenna and the shunt coil. As such, the protective circuit can also be used as a discrete matching network that can be optimized depending on the phone mechanics and dimensions.

### BRIEF DESCRIPTION OF THE DRAWINGS

FIG. 1 shows a typical non-50 ohm antenna.

FIG. 2 shows an equivalent circuit of a prior art fixed matching network for a non-50 ohm antenna.

FIG. 3a shows a prior art circuit for non-50 ohm antenna matching.

FIG. 3b shows another prior art circuit for non-50 ohm antenna matching.

FIG. 4a is a schematic representation of an RF front-end architecture, according to the present invention.

FIG. 4b is a schematic representation of another RF front-end architecture, according to the present invention.

FIG. 5a is a block diagram showing one part of the RF front-end architecture having two separated non-50 ohm antennas, according to the present invention.

FIG. 5b is a block diagram showing the another part of the RF front-end architecture, according to the present invention.

FIG. 6a is a block diagram showing one part of the RF front-end architecture having two separated non-50 ohm antennas, according to another embodiment of the present invention.

FIG. 6b is a block diagram showing the another part of the RF front-end architecture, according to the other embodiment of the present invention.

FIG. 7 is a schematic representation of a mobile terminal comprising the RF front-end, according to the present invention.

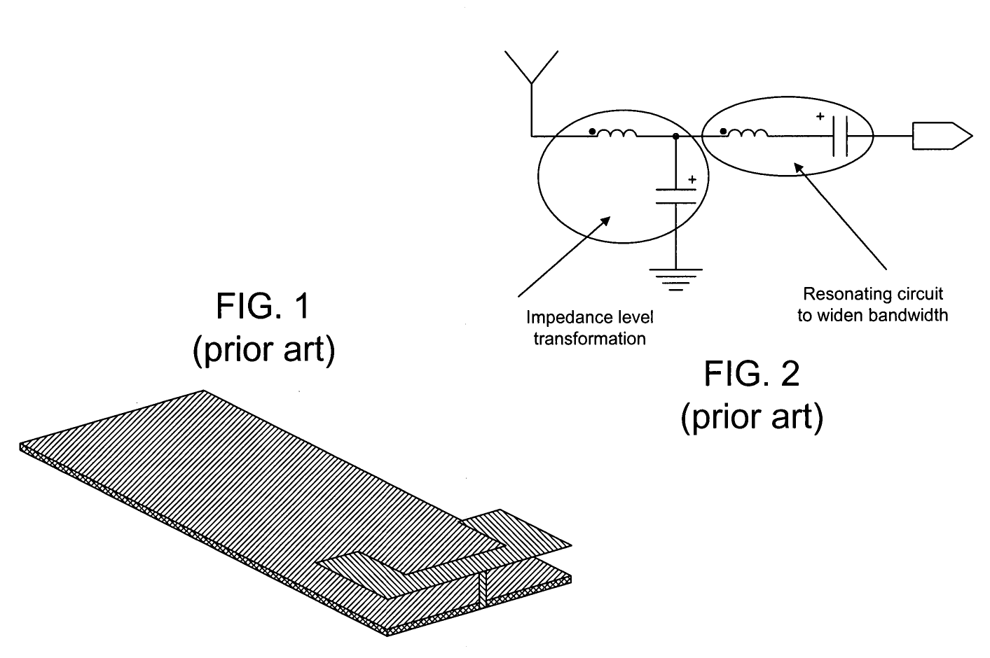

### DETAILED DESCRIPTION OF THE INVENTION

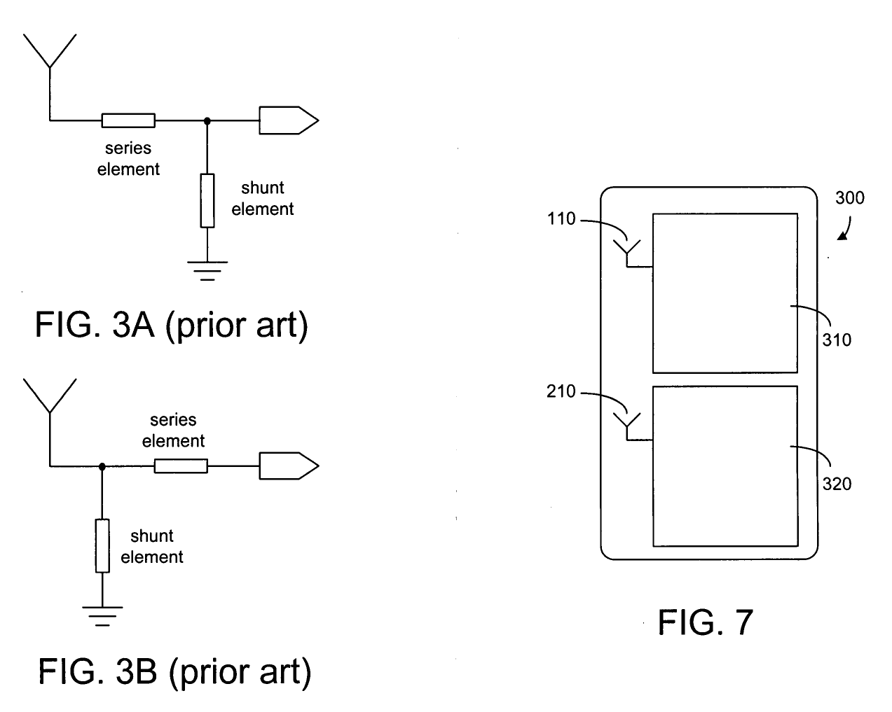

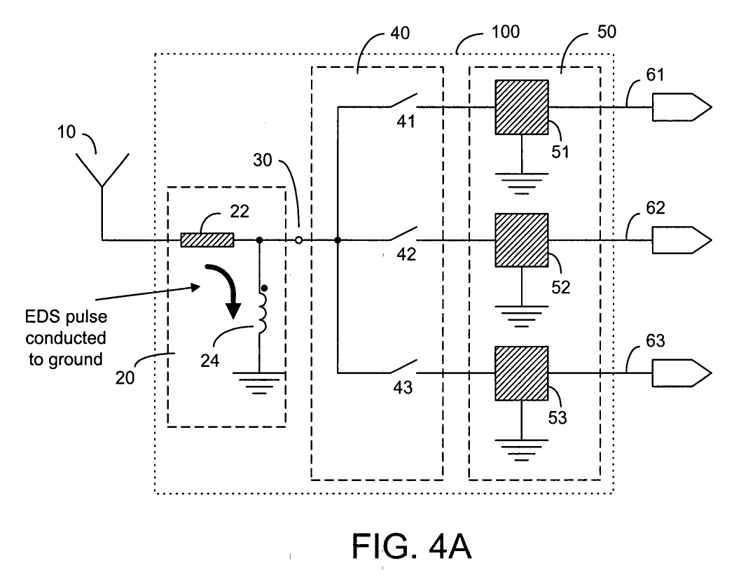

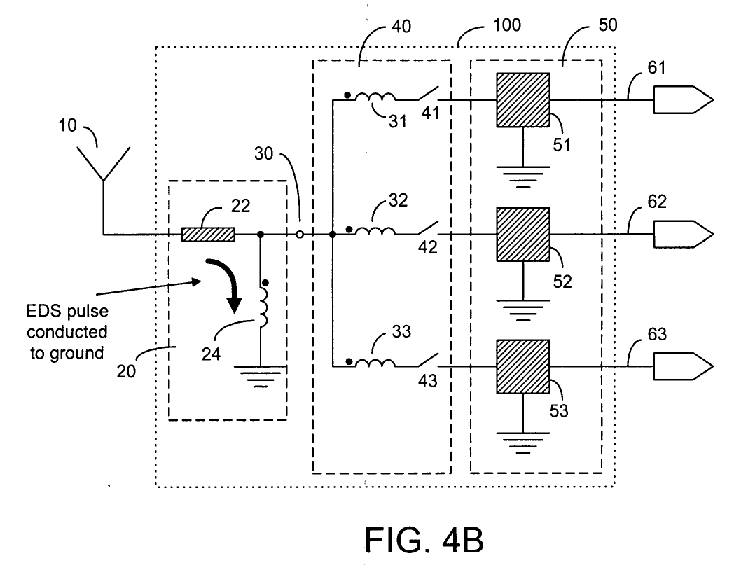

A general RF front-end architecture, according to the present invention, is shown in FIG. 4a. As shown, the RF front-end module 100 is connected to a non-50 ohm antenna 10. It is possible that the antenna 10 is also non-resonating. The RF front-end 100 comprises a switching module 40 and a matching module 50 to split the feed point to the antenna into a plurality of signal paths 61, 62, 63. As shown in FIG. 4a, the switching module 40 has a plurality of switching elements 41, 42, 43 for selecting the signal paths 61, 62, 63. Some of the signal paths 61, 62, 63 can be transmission paths and the others are reception paths. The matching module 50 has a plurality of matching networks 51, 52, 53 for separately and independently matching the antenna for the corresponding signal paths. Each of the matching networks can be as simple as those shown in FIGS. 3a and 3b. However, it is also desirable to include a resonating circuit to widen the bandwidth associated with each signal path. In addition, the front-end 100 has a matching network 20 connected between the antenna 10 and the switching module 40. The matching network 20 is used for electrostatic charge (ESD) protection and also used as a discrete matching network. The ESD pulse must be conducted to the ground as close to the antenna as possible. This matching network can also be used to optimize the antenna performance in accordance with the phone mechanics and dimensions. It can be used to compensate for small variations in the length of the connector connecting the antenna feed point and the front-end module 100, for example. Advantageously, a test point 30 is provided between the switching module 40 and the matching network 20 so that measurements and calibrations can be made without the antenna 10. As shown in FIG. 4A, the matching network 20 comprises a series element 22 and a shunt element 24. Each of these elements can be a capacitor or an inductor. For example, the shunt element 24 can be a coil at least partly used to compensate for the length of the connector connecting the antenna feed point and the front-end module.

In another embodiment of the present invention, additional coils or capacitors 31, 32, 33 can be connected in series in front of some or all of the switching elements 41, 42, 43, as shown in FIG. 4b. When the switch is open, the added matching component is in series with a very high impedance. As such, the added matching components 31, 32, 33 do not have significant effects on the other signal paths. With these added matching components, it is possible to compensate for the impedance changes due to moderate changes in the phone mechanics by varying the value of the added matching components. As such, it may be possible to use the same front-end module on different products.

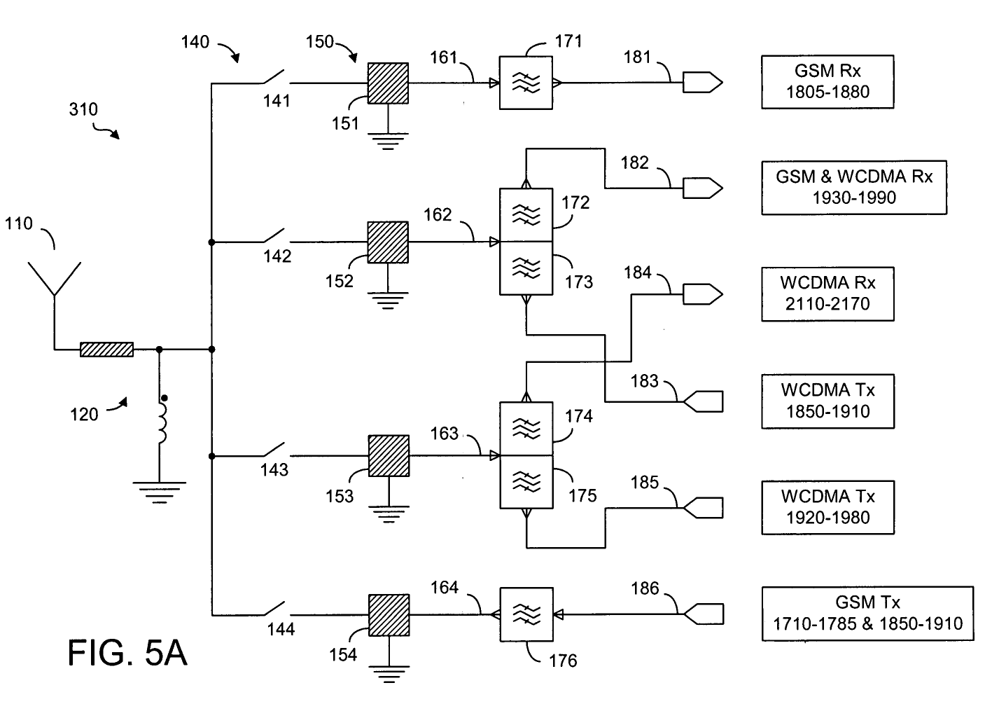

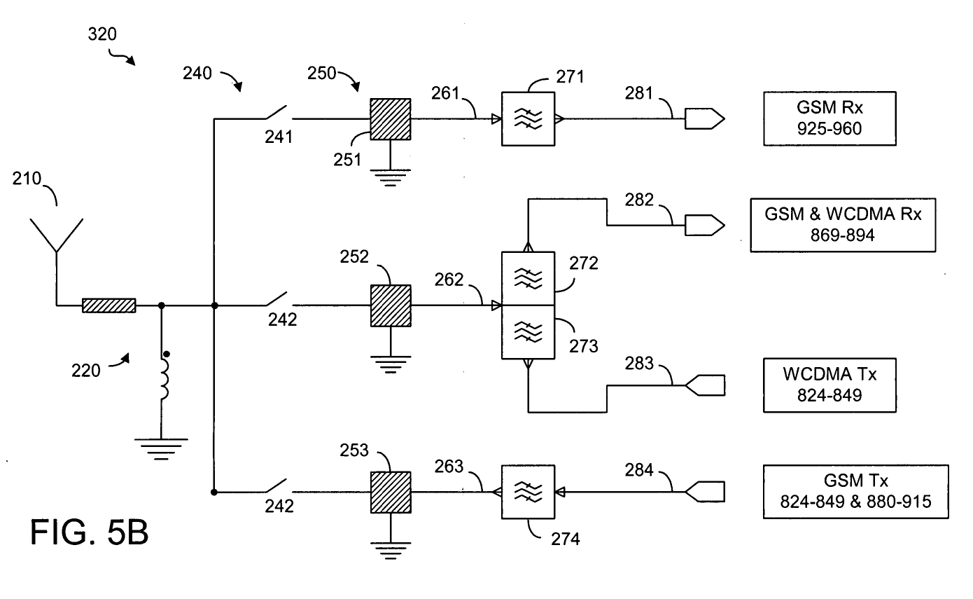

The present invention uses two separate antennas for separately providing transmission/reception paths for 1 GHz band and for 2 GHz band. FIG. 5a shows the antenna and the front-end module 310 for the 2 GHz band and FIG. 5b shows the antenna and the front-end module 320 for the 1 GHz band. As shown in FIG. 5a, the feed point of antenna 110 is split into four signal paths 161, 162, 163, 164 selectable by switching elements 141, 142, 143, 144 of the switching module 140. Each of the signal paths 161, 162, 163, 164 has a separate and independent matching network 151, 152, 153, 154 (see FIGS. 4a and 4b). Depending on what the signal paths are used for, each of the signal paths has one ore more bandpass filters 171, 172, . . . , 176 to filter the signals conveyed between paths 161, 162, 163, 164 and paths 181, 182, . . . , 186. For example, path 161 is used to convey signals in the 1805-1880 MHz GSM Rx mode and filter 171 is used to filter the signals before it conveys them to the path 181. Path 162 is used for both GSM/W-CDMA Rx (1930-1990 MHz) and W-CDMA Tx (1850-1910 MHz). The filters 172 and 173 constitute a duplex filter for the 1900 MHz WCDMA or CDMA system to separate simultaneous Tx and Rx signals from each other. Because the GSM 1900Rx signal is in the same frequency range, the filter 172 can also be used for GSM Rx. Likewise, filters 174, 175 constitute a duplex filter for the EU WCDMA band, to separate simultaneous EU WCDMA Rx (2110-2170 MHz) and EU WCDMA Tx (1920-1980 MHz) signals conveyed through path 163. Filter 176 is used to filter signals for GSM Tx (1710-1785 MHz) and (1850-1910 MHz) conveyed through path 164 and path 186. A protective matching network 120 is provided between the antenna 110 and the switching module 140.

In a similar manner, the feed point of antenna 210, as shown in FIG. 5b, is split into three signal paths 261, 262, 263 selectable by switching elements 241, 242, 243 of the switching module 240. Each of the signal paths 261, 262, 263 has a separate and independent matching network 251, 252, 253 (see FIGS. 4a and 4b). Depending on what the signal paths are used for, each of the signal paths has one or more bandpass filters 271, 272, 273, 274 to filter the signals conveyed between paths 261, 262, 263 and paths 281, 282, 283, 284. In particular, path 261 is used to convey signals in the 925-960 MHz GSM Rx mode and filter 271 is used to filter the signals before it conveys them to the path 281. Path 262 is used for both GSM/ W-CDMA Rx (869-894 MHz) and W-CDMA Tx (824-849 MHz). The filters 272 and 273 constitute a duplex filter to separate simultaneous WCDMA Tx and WCDMA Rx signals from each other. Because the GSM 850 Rx signal is in the same frequency range, the filter 272 can also be used for GSM Rx. Likewise, filter 274 is used to filter signals for GSM Tx (824-849 MHz)/(880-915 MHz) conveyed through path 263 and path 284. A protective matching network 220 is provided between the antenna 210 and the switching module 240.

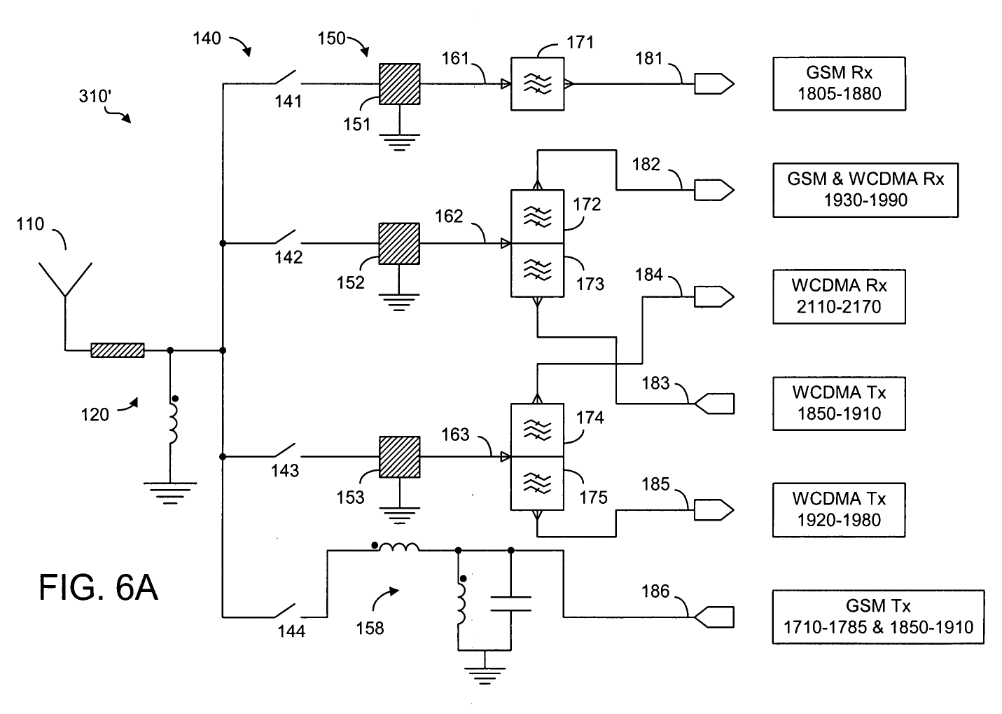

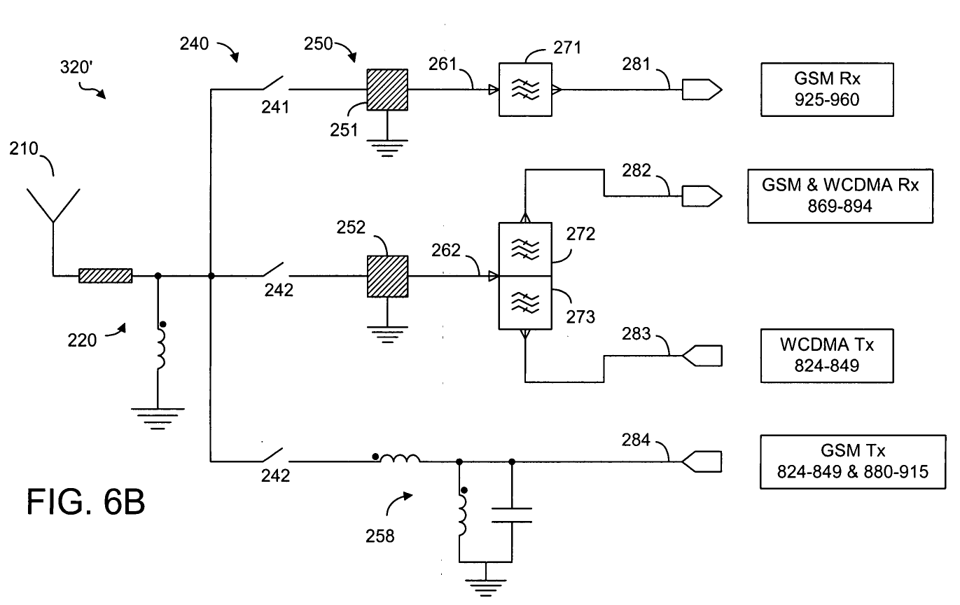

It should be noted that the filters 176 and 274 are mainly used to attenuate the harmonic frequencies generated or amplified in power amplifiers (not shown) in the corresponding signal paths. Thus, these filters do not have to be very selective. In a typical case, the matching elements in these signal paths would provide sufficient attenuation and filtering and no additional filters are needed. In practice, filter 176 in FIG. 5A is not necessary, and it is drawn to show the filtering function achievable by a matching network. For example, the matching network 158 can be used for both matching and filtering for the GSM Tx path 186, as shown in FIG. 6A. Likewise, filter 274 in FIG. 5B is not necessary. A matching network 258 can be used for both matching and filtering for the GSM Tx path 186, as shown in FIG. 6B. It should be noted that, a Tx signal path is connected to a power amplifier (PA) and an Rx path is connected to a linear amplifier (LNA). PA output impedance is typically below 50 ohm and the LNA input impedance level may be over 50 ohm. Thus, signal path impedance can differ from 50 ohm. Although the ports for signal paths 181, 182, . . . , 186 use the same antenna 110 as shown in FIG. 5A, the matching networks 151, 152, 153, 154 can be designed such that some of the ports have different impedance levels than the other ports. For example, it is possible that the matching network 154 on the GSM Tx signal path 186 is designed such that the power amplifier (not shown) for this signal path sees an impedance level of 20 ohm or lower, which is closer to a typical power amplifier output. However, the matching network 151 on the GSM Rx signal path 181 can be designed to provide an impedance level equal to or higher than 50 ohm so that higher filter performance can be achieved. Likewise, the matching network 251 on the GSM Rx signal path 281, as shown in FIG. 5B, provides a higher impedance than the matching network 253 on the GSM Tx signal path 284. Thus, in one aspect of the prevent invention, matching optimization in the transmitter side is to match the lower PA impedance, whereas matching optimization in the receiver side is to match the higher LNA impedance.

In sum, the present invention uses two separate antennas for separately providing transmission/reception paths for 1 GHz band and for 2 GHz band. The antennas are non-50 ohm antennas and possibly non-resonating. A switching module is operatively connected to each antenna for mode and frequency-range selection within each band. Each switching module has a plurality of switching elements connected to a plurality of signal paths. Matching is separately and independently provided for each signal path. Depending on the benefits desired, some signal paths see higher impedance levels than the other signal paths. An electro-static discharge protection circuit provided between the antenna feed point and the switching module can also be used as a discrete matching network to optimize the efficiency of the antenna.

The matching between the switch and the filter can be optimized for each frequency range separately and independently, whereas the protective matching network directly provided at the feed point of the antenna can be optimized for the 1 GHz band or 2 GHz band in general. One of the benefits of splitting the system into a 1 GHz band module and a 2 GHz band module is that the elements between the antenna and the front-end module can be optimized for each band. Such splitting simplifies the antenna design and tuning process. When a new variant of a mobile phone is launched with slightly different mechanics, a new antenna is usually needed to suit the new mechanics. However, the same front-end module can still be used. Another benefit of the splitting is that, the performance of mobile phones is usually measured in a 50 ohm environment without an antenna during manufacturing. A single capacitor, for example, can be added in order to match the 50 ohm environment. However, the additional capacitor can usually provide a wide-band match sufficient to cover either the 1 GHz band or the 2 GHz band, but not both. The antenna 10, as shown in FIGS. 4a and 4b, can be a planar inverted-F antenna (PIFA) or a planar inverted-L antenna (PILA). It can be a resonant antenna or preferably non-resonant antenna. It can also be a device used for transmitting or receiving radio waves, or a device for coupling radio waves to and from a metal chassis such as a PWB or other metal parts in a mobile phone, so long as that component can be designed to have its impedance in the capacitive region of the Smith Chart. The splitting of the antenna into two provides the possibility of also having the 2 GHz antenna in the capacitive region of the Smith Chart. Furthermore, the protective matching network, the switching module and the matching networks between the switches and the filters can be integrated into a module.

The use of non-resonant antennas and the external shunt/series inductors in the protective matching network together with the passive integrated capacitors and/or coils in the front-end module can maximize the efficiency of the antenna/front-end combination. External discrete inductors and integrated capacitors are generally suitable for high-Q tuning.

In general, with the matching networks implemented on both sides of the switching module, the total efficiency of a mobile phone is less sensitive to the user position. At the same time, the mobile phone has sufficient protection for ESD.

The RF front-end, as shown in FIGS. 5a -6b, can be used in a communications device, such as a mobile phone as shown in FIG. 7.

Although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A front-end for use in a transceiver having a non-50 ohm antenna having a feed point for transmitting and receiving signals in a plurality of frequency ranges, said front-end comprising:
a switching module having a plurality of switching elements, each switching element having a first end and an opposing second end, the first end operatively connected to the feed point of the antenna, the second end operatively connected to a signal path for conveying the signals in one of the frequency ranges;
a plurality of matching networks for separately matching the signal paths to the antenna; and
a further matching network operatively connected to the feed point of the antenna, located between the switching module and the antenna.

2. The front-end of claim 1, wherein the switching module is located between the matching networks and the further matching network.

3. The front-end of claim 1, wherein the further matching network comprises a shunt element and a series element.

4. The front-end of claim 3, wherein the shunt element comprises an inductor to compensate for a length of the feed point.

5. The front-end of claim 2, wherein the switching module further comprises a series element located between the further matching network and at least one of the matching networks.

6. The front-end of claim 1, wherein one of the signal paths is for conveying the transmitting signal in a GSM mode, and wherein the matching network for matching said one signal path comprises matching elements for filtering the transmitting signal.

7. The front-end of claim 1, wherein at least one of the signal paths comprises a bandpass filter for filtering the signals.

8. The front-end of claim 1, wherein at least one of the matching networks is operatively connected to a transmission path and a reception path for conveying signals in CDMA frequency ranges, said front-end further comprising a duplex filter for separating the signal in the transmission path and the signal in the reception path from each other.

9. The front-end of claim 1, wherein at least one of the matching networks provides an impedance level lower than 50 ohm.

10. The front end of claim 1, wherein at least one of the matching networks provides an impedance level equal to or higher than 50 ohm.

11. The front end of claim 1, wherein at least one of the matching networks provides an impedance level below 50 ohm and at least one of the matching networks provides an impedance level equal to or higher than 50 ohm.

12. A multi-band, multi-mode transceiver system, comprising:
a first non-50 ohm antenna for transmitting and receiving signals in a plurality of frequency ranges in a first frequency band, the first antenna having a feed point;
a second non-50 ohm antenna for transmitting and receiving signals in a plurality of further frequency ranges in a second frequency band, the second antenna having a feed point; and
at least a front-end module and a second module, each front-end module comprising:
a switching module having a plurality of switching elements, each switching element having a first end and an opposing second end, the first end operatively connected to the feed point of the respective antenna, the second end operatively connected to a signal path for conveying the signals of one of the frequency ranges in the respective frequency band;
a plurality of matching networks for separately matching the signal paths to the respective antenna; and
a further matching network operatively connected to the feed point of the respective antenna, located between the switching module and the respective antenna.

13. The transceiver system of claim 12, wherein the first frequency band is a 1 GHz band and the second frequency band is a 2 GHz band.

14. The transceiver system of claim 13, wherein the signals in the first frequency band include:
GSM Rx signals substantially in the frequency range of 1805-1880 MHz;
GSM and WCDMA Rx signals substantially in the frequency range of 1930-1990 MHz;
WCDMA Rx signals substantially in the frequency range of 2110-2170 MHz;
WCDMA Tx signals substantially in the frequency range of 1850-1910 MHz;
WCDMA Tx signals substantially in the frequency range of 1920-1980 MHz; and
GSM Tx signals substantially in the frequency range of 1710-1785 MHz and in the frequency range of 1850-1910 MHz.

15. The transceiver system of claim 13, wherein the signals in the second frequency band include:
GSM Rx signals substantially in the frequency range of 925-960 MHz;
GSM and WCDMA Rx signals substantially in the frequency range of 869-894 MHz;
WCDMA Tx signals substantially in the frequency range of 824-849 MHz;
GSM Tx signals substantially in the frequency range of 824-849 MHz and in the frequency range of 880-915 MHz.

16. The transceiver system of claim 12, further comprising a plurality of bandpass filters for filtering signals in the respective frequency ranges.

17. The transceiver system of claim 12, wherein the further matching network comprises a shunt element and a series element.

18. The transceiver system of claim 12, wherein the switching module further comprises a series element located between the further matching network and at least one of the matching networks.

19. The transceiver system of claim 14, further comprising another matching network for providing matching and filtering in the signal path for conveying GSM Tx signals.

20. The transceiver system of claim 15, further comprising another matching network for providing matching and filtering in the signal path for conveying GSM Tx signals.

21. The transceiver system of claim 14, wherein one of the signal paths is for conveying the transmission signal and reception signal in a CDMA mode, and wherein said first front-end further comprises a duplex filter for separating the transmission signal and the reception signal from each other in the respective paths.

22. The transceiver system of claim 15, wherein one of the signal paths is for conveying the transmission signal and reception signal in a CDMA mode, and wherein said first front-end further comprises a duplex filter for separating the transmission signal and the reception signal from each other in the respective paths.

23. A mobile terminal comprising the multi-band, multi-mode transceiver system according to claim 12.
